(19) United States
(12) Patent Application Publication
(10) Pub. No.: US 2017/0041645 A1
(43) Pub. Date: Feb. 9, 2017

(54) METHOD FOR TRANSMITTING DIGITAL IMAGES FROM A SERIES OF IMAGES

(71) Applicant: SIEMENS AKTIENGESELLSCHAFT, München (DE)

(72) Inventor: PETER AMON, MÜNCHEN (DE)

(21) Appl. No.: 15/119,134

(22) PCT Filed: Feb. 26, 2015
(86) PCT No.: PCT/EP2015/054025

§ 371 Date: Aug. 16, 2016

(30) Foreign Application Priority Data
Mar. 25, 2014 (DE) 102014205485.0

(51) Int. Cl. H04N 21/238; H04N 21/2343; H04N 21/845

(52) U.S. Cl. CPC H04N 21/238; H04N 21/8456; H04N 21/23439

(57) ABSTRACT

A method for transmitting digital images from a series of images for which an image sequence of the images is specified is provided. The series of images is stored on a server in the form of segments, and each segment includes one or more images which are adjacent to one another according to the image sequence. A client requests images from the server on the basis of the segments, and the server then at least partly transmits the images from the requested segments to the client, wherein the images are stored in a buffer in the client and are at least partly reproduced. The client checks the request of additional images from the server at the time of the reproduction of a current image on the basis of a specified priority rule.

### CROSS-REFERENCE TO RELATED APPLICATIONS

This application claims priority to PCT Application No. PCT/EP2015/054025, having a filing date of Feb. 26, 2015, based off of DE Application No. 10 2014 205 485.0 having a filing date of Mar. 25, 2014, the entire contents of which are hereby incorporated by reference.

### FIELD OF TECHNOLOGY

The following relates to a method for transmitting digital images from a series of images and to a corresponding system for transmitting digital images and to a corresponding client for use in a system for transmitting digital images.

### BACKGROUND

For a multiplicity of applications, it is desirable to display images from a series of images, which are stored on a remote server, on a client. For example, in medicine, series of images are often reproduced in the form of successive sectional images of the human or animal body on a client which requests the images from a remote server for this purpose. In contrast to conventional video streaming, it is not known in this context in what order a user (e.g. a radiologist) views the images on the client. In this context, an unwanted delay of the image display may occur if the user requests images via the client which have previously not yet been transmitted from the server to the client.

From the prior art, it is known that in the reproduction of image data and particularly medical image data, the entire record of the images is downloaded from the server to the client before the images are displayed. However, this leads to a high time delay until the viewing of the images can be begun.

From the prior art, server-side streaming of image data is also known in which a user specifies the section of a video desired by it at a client. This information is given to the server which then streams the corresponding image data to the client.

The disadvantage of this method is that in the case where the user changes the point of reproduction in the video stream, a time delay occurs until the video stream is displayed starting from the new point of reproduction. Furthermore, the images reproduced at the client are discarded after they have been displayed so that in the case of interruption of the link to the server, no further navigation is possible in the image data.

From the prior art, an adaptive streaming of image data is also known. Such a streaming is described, e.g. in the MPEG-DASH standard. In the document Sodagar, “The MPEG-DASH Standard for Multimedia Streaming Over the Internet” in IEEE MultiMedia, vol. 18, no. 4, pages 62-67, April 2011, it is explained with reference to the MPEG-DASH standard (MPEG Motion Picture Expert Group, DASH Dynamic Adaptive Streaming over HTTP, HTTP Hypertext Transfer Protocol) that, by means of an adaptive streaming, the image quality of the images streamed by a server at a client can be suitably adapted in dependence on the transmission rate between server and client. For this purpose, the images are present in different qualities in the server and with a decrease in the data rate, the images are transmitted with lower quality. However, this does not ensure that it is possible to navigate in the series of images without time delay between different points of reproduction, possibly with a change in the image quality.

### SUMMARY

An aspect relates to a method for transmitting digital images from a server to a client, in which it is possible to navigate in a simple and rapid manner in the images on the side of the client.

The method according to embodiments of the invention is used for transmitting digital images from a series of images for which an image sequence of the images is specified. In the case of conventional video streaming, the image sequence can correspond to the temporal direction of reproduction of the video stream. Similarly, the image sequence can represent a spatial direction as will be described below with reference to medical image data. The series of images is stored in the form of segments on a server, a respective segment comprising one or more images which are adjacent to one another according to the image sequence. A client requests images from the series of images on the basis of the segments at the server which thereupon transmits the images from the requested segments at least partially to the client, in which the images are stored in a buffer and reproduced at least in part.

In the course of the method according to embodiments of the invention, the client checks at the time of reproduction of a current image (i.e. during the current reproduction of a corresponding image) the request of further images from the series of images from the server on the basis of a specified priority rule, in the course of checking the requesting of a respective further image the client requesting a segment which comprises the respective further image if the further image is not present in the buffer. Checking the requesting of a further image thus also comprises the step of actually requesting if the image is not present in the buffer of the client.

The method according to embodiments of the invention is characterized by the special configuration of the specified priority rule. According to the specified priority rule, the client first (i.e. at the beginning of the reproduction of the current image) checks the requesting of further images which follow the current image both in the direction of the image sequence and in opposition to the direction of the image sequence. In particular, these images are then images which are immediately adjacent to the current image both in the direction of the image sequence and in opposition to the direction of the image sequence. Alternatively or additionally, the specified priority rule is characterized by the fact that firstly the requesting of at least one further image is checked which corresponds to the current image in a higher image quality than that of the current image. If the checking of the requesting is based on both of the variants of the priority rule just mentioned, this checking is initially carried out on the basis of both variants in an arbitrary sequence of the variants with respect to one another, before the requesting of images is checked also in deviation from these variants.

The method according to embodiments of the invention has the advantage that in the case of a navigation on the side of the client in or in opposition to the image sequence or towards a higher image quality of the current image, no time delay occurs in the image reproduction. The method is thus suited particularly for displaying image data in which there is no preferred direction of image reproduction as is the case, for example, in the display of medical images.

The priority rule according to embodiments of the invention does not necessarily have to be used every time when a current image is reproduced. The specified priority rule is preferably used whenever the transmission of the digital images just starts, i.e. when there are no images yet in the buffer of the client. Various criteria can be specified under which conditions the specified priority rule is used during the reproduction of a current image. Naturally, the possibility also exists that the predetermined priority rule is used with each reproduction of a current image.

The above concept of image quality is understood to be wide and can relate to arbitrary quality criteria with regard to each individual image. In particular, the image quality can be defined in such a manner that it increases with a higher pixel accuracy of the image (e.g. due to better quantization, i.e. a quantization with smaller step widths) and/or that it increases due to a higher local resolution of the image (i.e. more pixels per image) and/or that it increases with a greater bit depth (i.e. more bits per pixel).

In a particularly preferred embodiment, specified identical image contents are in each case described by a number of segments having different image qualities, the number of segments differing in the image quality of the images contained therein.

In a particularly preferred variant, the segments which are transmitted from the server to the client comprise coded images which are decoded for display at the client.

In a further embodiment, the segments having the different image qualities are coded with different coding methods and/or different quality levels of the same coding method. The different coding methods can comprise, e.g., H.264 and/or H.265 and/or JPEG-LS and/or JPEG-lossless (JPEG-Joint Picture Expert Group, LS—Lossless). JPEG-LS designates an ITU-T T.87 standard. The different quality levels of the same coding method can relate to layers of a scalable video coding, particularly to layers of H.264-SVC and/or layers of H.265-SHVC (SVC—Scalable Video Coding, SHVC—scalable extension of HEVC, HEVC—High Efficiency Video Coding). HEVC is also known as H.265.

In the case where the segments transmitted to the client comprise coded images, these images are stored at least in part in decoded form in the buffer in the client in a variant of embodiments of the invention, i.e. the images are decoded before storage in the buffer. If necessary, all transmitted images are stored in the buffer in decoded form. This avoids multiple decoding of images in the case of repeated display.

For transmitting the digital images, the MPEG-DASH standard mentioned initially is used in a preferred variant of the method according to embodiments of the invention.

In a further embodiment of the method according to embodiments of the invention, the specified priority rule is altered in dependence on predetermined events. Depending on design, the altered priority rule can still have the properties of the specified priority rule as defined above or may also deviate therefrom.

In a variant of the method according to embodiments of the invention, the specified priority rule is altered in dependence on the data rate of the transmission from the server to the client, the alteration of the priority rule being designed in such a manner that the client requests images having a higher image quality at higher data rates than at lower data rates. In this way, the image quality is adaptively adapted to the existing data rate. Alternatively or additionally, the specified priority rule can be altered by a user command input at the client for altering the specified priority rule. In other words, the priority rule can be adapted directly via a user interaction in this case.

In a further variant of the method according to embodiments of the invention, a direction of navigation is determined by the client on the basis of the movement of the current images in the direction or in opposition to the direction of the image sequence, wherein, according to the specified priority rule and/or according to the altered priority rule, the client requests, starting from the image currently reproduced, those other images which follow the current image in the direction of navigation, preferably in comparison with those other images which follow the current image in opposition to the direction of navigation. This takes into consideration in which direction other images will probably be displayed at the client so that these images are obtained preferably from the server.

In a further embodiment of the method according to embodiments of the invention, the specified priority rule and/or the altered priority rule defined above specifies that for particular segments requested by the client, only a part of the images contained therein are transmitted from the server to the client. In this manner, the resolution of the images can also be adapted on the basis of the direction of the image sequence.

As already mentioned above, the series of images preferably comprises digital medical images. These images represent sections of a human or animal body which follow one another in a spatial direction, the spatial direction corresponding to the image sequence defined above.

Apart from the method described above, embodiments of the invention also relates to a system of server and client for transmitting digital images from a series of images for which an image sequence of the images is specified, the series of images being stored in the form of segments on the server and a respective segment comprising one or more images which, according to the image sequence, are adjacent.

In this system, the client comprises the following components:
a requesting means for requesting images on the basis of the segments at the server;
a buffer for storing images from the series of images;
a reproducing means for reproducing at least a part of the images from the buffer.

By comparison, the server of the transmission system comprises:
a memory in which the stored images are stored;
a transmitting means for transmitting the images from the segments requested by the client at least partially to the client.

The requesting means of the client is then designed in such a manner that:
the requesting means checks at the time of reproduction of a current image by the reproducing means the requesting of further images by the server on the basis of a specified priority rule, in the course of checking a respective further image the requesting means requesting a segment which comprises the respective further image if the respective further image is not present in the buffer;
wherein the priority rule is designed in such a manner that initially the requesting of further images is checked which follow the current image both in the direction of the image sequence and in opposition to the direction of the image sequence and/or initially the requesting of at least one further image is checked which corresponds to the current image in a higher image quality than that of the current image.

The transmission system according to embodiments of the invention is preferably designed in such a manner that one or more preferred variants of the method according to embodiments of the invention can be performed by means of the transmission system.

The following additionally relates to a client, i.e. a computer acting as client, for use in a system for transmitting digital images from a series of images for which an image sequence of the images is specified, the series of images being stored on a server in the form of segments and a respective segment comprising one or more images which are adjacent in accordance with the image sequence.

This client comprises:
a requesting means for requesting images on the basis of the segments at the server and by this means to cause the server to transmit the images from the requested segments at least partially to the client;
a buffer for storing images from the series of images;
a reproducing means for reproducing at least a part of the images from the buffer.

In this context, the requesting means of the client is designed in such a manner that:
the requesting means checks at the time of reproduction of a current image by the reproducing means the requesting of further images by the server on the basis of a specified priority rule, in the course of checking a respective further image the requesting means requesting a segment which comprises the respective further image if the respective further image is not present in the buffer;
the priority rule being designed in such a manner that initially the requesting of further images is checked which follow the current image both in the direction of the image sequence and in opposition to the direction of the image sequence and/or initially the requesting of at least one further image is checked which corresponds to the current image in a higher image quality than that of the current image.

The client according to embodiments of the invention is preferably provided for use in one or more preferred variants of the method according to embodiments of the invention for transmitting digital images. In other words, the client can contain the features of preferred variants of the method according to embodiments of the invention in the form of corresponding device features if the features relate to the client.

Exemplary embodiments of the invention will be described in detail in the text which follows by means of the attached figures.

### BRIEF DESCRIPTION

Some of the embodiments will be described in detail, with reference to the following figures, wherein like designations denote like members, wherein:

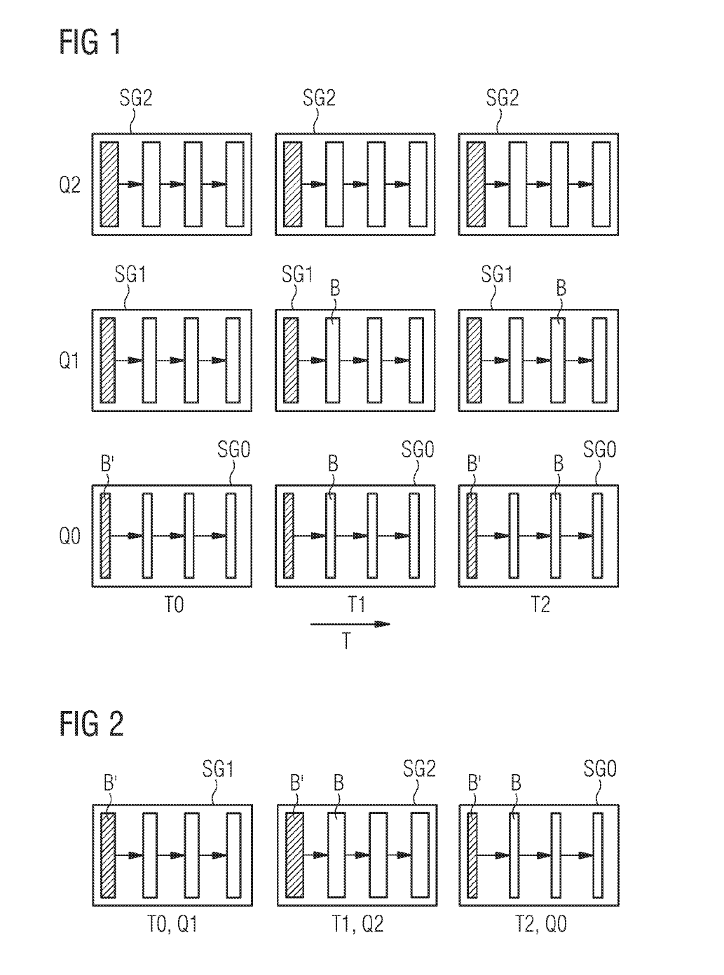

FIG. 1 shows an example of the segments, stored in a server, for performing adaptive streaming according to the prior art;

FIG. 2 shows an example of the segments received in a client based on adaptive streaming according to the prior art;

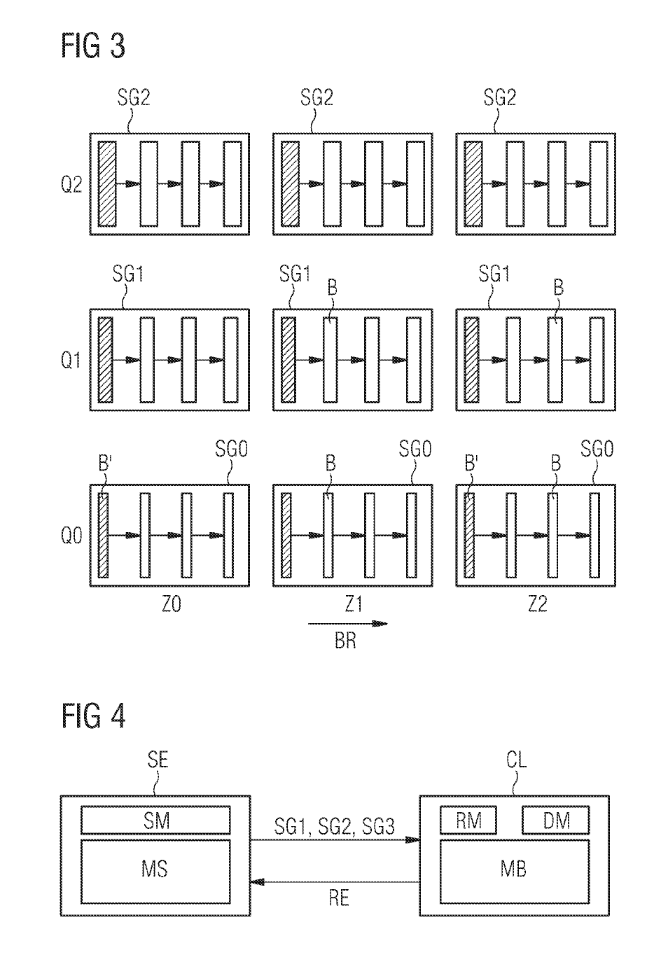

FIG. 3 shows a diagrammatic representation of the segments stored in a server for performing an embodiment of the method;

FIG. 4 shows a diagrammatic representation of a transmission system by means of which a variant of the method is performed;

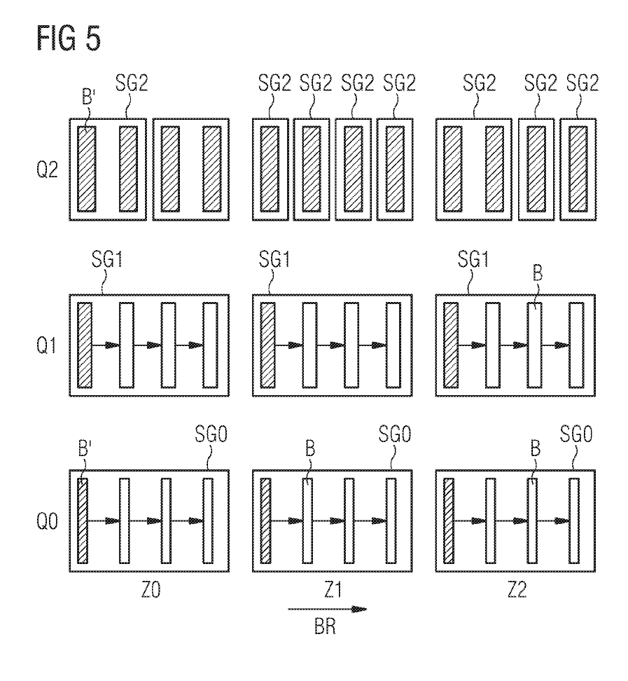

FIG. 5 shows an example of segments stored in a server for executing variants of the method;

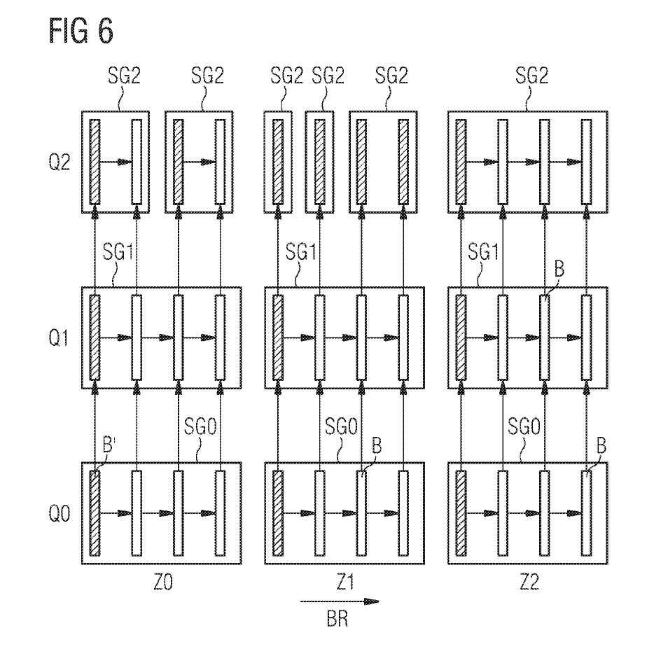

FIG. 6 shows an example of segments stored in a server for executing variants of the method; and

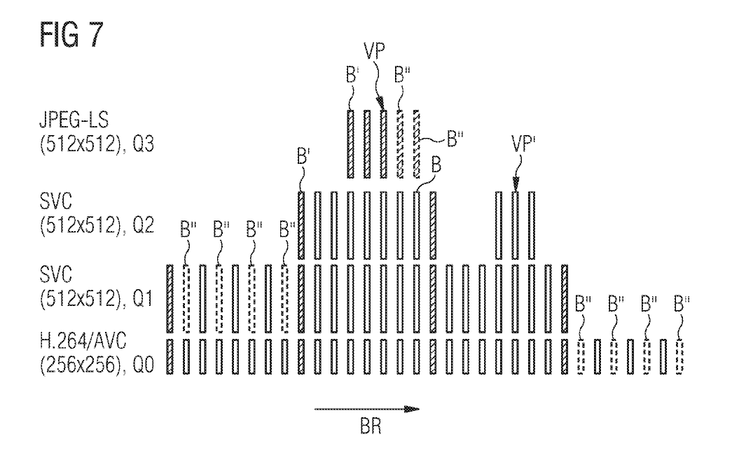

FIG. 7 shows a diagrammatic representation of the snapshot of a buffer of a client in an embodiment of the transmission system.

### DETAILED DESCRIPTION

Before an embodiment of the method according to embodiments of the invention is explained in detail, a conventional adaptive streaming of video data will first be described. The streaming takes place here via HTTP and is based on the MPEG-DASH standard which can also be used in combination with the method according to embodiments of the invention. This standard specifies, among other things, formats for segments of images to be transmitted, but does not define the sequence in which the segments are transmitted from a server to a client.

FIG. 1 shows a diagram which shows an excerpt of the organization of video data which are stored on a server from which the video data are requested by a client and downloaded. In this context, the horizontal axis T indicates the direction of time in which the corresponding video is replayed. The individual images of the video are indicated by bars. In this context, the images are coded, with white bars B representing inter-coded images and shaded bars B′ representing intra-coded images. For reasons of clarity, not all bars are provided with the said reference symbols. Corresponding horizontal arrows indicate the dependencies between the coded images. That is to say an image at which a corresponding arrow ends needs the image at which the arrow begins for decoding.

The images are combined in a number of segments, there being in each case segments SG0, SG1 and SG2 lying above one another in a corresponding time interval T0, T1 and T2, respectively. The segments lying above one another are related to the same image content but code it with different image quality. Q0 here designates a low image quality, Q1 a medium image quality and Q2 a high image quality. The index of the segments is thus related to the image quality. The concept of image quality has already been defined above and can relate, in particular, to a higher pixel accuracy, a higher local resolution or a higher bit depth of the respective image. A higher image quality necessitates a greater amount of data per image which is indicated in FIG. 1 by a greater thickness of the bars representing the images at the different quality levels Q0, Q1 and Q2. The designations SG0, SG1 and SG2, just explained, for the segments of the different quality levels Q0, Q1 and Q2 and the designations B and B′, respectively, for inter-coded and intra-coded images, respectively, will be retained in the FIG. 3 described in the text which follows.

In the course of adaptive streaming, a client has the option, in dependence on the available data rate on the transmission path between server and client, to request the corresponding segments variably in different ones of the three quality levels Q0, Q1 and Q2 at the server. This is illustrated by means of FIG. 2. This figure shows, for example, the transmission of three segments from FIG. 1 from a server to a client. At time interval T0, segment SG1 is here transmitted with medium quality Q1. In the time period T2, a particularly high data rate is present so that the quality of the transmitted images is increased and thus the segment SG2 is transmitted with the highest quality. By comparison, the data rate distinctly drops off at time interval T2 so that segment SG0 is transmitted with the lowest quality level in this time interval.

Requesting or transmitting the segments shown in FIG. 2 occurs with a lead time before the reproduction of the segments. This lead time is needed so that the images of the segments can be decoded in time before their reproduction at the client and there will thus not be any time delays and freezing of video images. The reproduction of the images can also be controlled in the client by a user, i.e. the user can alter the point of reproduction or the location of display in the video whereupon the streaming of the video data starts from the desired point of display and the corresponding segments of the video data are downloaded starting from the point of display and buffered at the client.

Although the adaptive video streaming just described enables the image quality of the images received from the client to be adapted, images starting from the current point of reproduction cannot be obtained from the server both in and in opposition to the direction of time of the video stream or in a number of quality levels for the same image contents.

FIG. 3 diagrammatically shows the organization of segments in a server, the segments being transmitted to the client on the basis of an embodiment of the method according to embodiments of the invention. In this arrangement, the organization and structure of the segments correspond to the example of FIG. 1, the only difference being that the images shown are not a video stream progressing in time but medical sectional images which have been recorded, e.g. via a computer tomograph. The sectional images are two-dimensional sections through a human body which have been performed perpendicularly to a predetermined spatial direction in the body (frequently also called z direction) for successive positions along this spatial direction. Accordingly, the segments are now no longer related to time intervals T0, T1 and T2 but to corresponding spatial distances Z0, Z1 and Z2. The specified spatial direction proceeds along the axis BR, this axis corresponding to a predetermined image sequence in the sense of the patent claims. The definition of this image sequence is here arbitrary and does not represent any preferred direction of image reproduction. In particular, a user can have the images reproduced arbitrarily both in the image sequence and in opposition to the image sequence.

In contrast to conventional video data, it is of particular importance to a user in the case of the display of medical images that the user can navigate rapidly between different images and different quality levels of the images in order to perform by this means, e.g., the diagnosis of illnesses. In order to ensure in this context, that the streamed images are displayed without time delay for the user if possible, the images are requested by the client at the server on the basis of the priority rule or priority sequence described in the text which follows.

In a first step, the corresponding segment with this sectional image is requested from the server starting from the point of reproduction selected by the user (i.e. a desired sectional image along axis BR). Preferably, the segment having the lowest quality level is then transmitted first in order to enable the image to be displayed rapidly. The transmitted segment is decoded in a manner known per se and reproduced on a corresponding display device or a display at the client. During the reproduction of the image, images are now requested both in the direction of the image sequence BR and in opposition to this sequence from the server in distinction to the conventional video streaming described above. For example, the sequence of priority can be defined as follows:
with the highest priority, images immediately adjacent to the image currently displayed are obtained both in or in opposition to the image sequence (i.e. adjacent images);
with the next-lower priority, images are obtained which are neighbors of adjacent images obtained in accordance with the highest priority (i.e. neighbors of adjacent images);
with the next-lower priority, the image currently displayed is obtained with a higher quality level;
with the next-lower priority, further adjacent images having even greater distance from the image currently displayed are obtained.

The priority sequence can be continued in a suitable manner. If necessary, the above priority sequence can also be changed in such a manner that with the highest priority, the image quality of the image currently displayed is initially improved, i.e. segments having the same image content of the segment of the image currently displayed but having higher image quality are requested first at the server.

In a next step, the dependencies in respect of other images are determined for the images to be obtained in accordance with the priority sequence. In particular, the case may occur that the decoding of the image to be obtained depends on other images. If this is the case, these other images are transmitted first in the transmission of the corresponding segment. Following this, downloading of the segment occurs on the basis of the priority sequence defined, taking into consideration the decoding dependency. In this context, particular segments can already be present in the buffer of the client because they have been obtained already from the server, e.g. at another point of reproduction. Such segments will not be requested again.

As soon as a user changes his point of reproduction in the image data, the method just described begins again from the front, i.e. the image of the current point of reproduction is downloaded and displayed, the procurement of further images from the server taking place on the basis of the priority sequence during the display of this image.

If necessary, the possibility also exists that the above priority sequence is changed, e.g. if the transmission rate between server and client changes. Similarly, the priority sequence can be adapted, e.g. on the basis of a user interaction. Furthermore, the priority rule can specify that no further images are obtained during the current reproduction if there are already sufficiently many images from the neighborhood.

In the text which follows, an actual scenario will be explained again how the segments of medical images, shown in FIG. 3, can be obtained by a client. Firstly, an initial point of reproduction is selected by the user at the client, i.e. the medical sectional image is selected which is to be displayed first. This image can be located at an arbitrary point along the spatial direction BR. The image is transmitted from server to client, then decoded there and reproduced. The image can be requested, e.g. initially in low quality Q0, in order to provide for a rapid display, the same image subsequently being obtainable in higher image qualities (e.g. in quality Q1 or Q2). As soon as a higher quality is available at the client, this image is decoded and displayed instead of the image having a lower quality.

If the priority sequence is defined in such a manner that an image having higher quality with respect to the image currently displayed is not necessarily needed immediately, images around the image currently reproduced, i.e. the adjacent images described above, are downloaded instead. In this context, the adjacent images both in the direction of the image sequence BR and in opposition to this direction are obtained from the server. This takes into account the fact that it is not known in advance in which direction a user wishes to look at further sectional images of the human body. As a rule, adjacent images are first obtained which have a low quality so that the images are already downloaded in the case of the change of the point of reproduction and are available in the client. As soon as an adequate number of adjacent images having low quality has been downloaded to the client, the client may also be able to request adjacent images having a higher image quality at the server.

If necessary, the order of procurement of images described above can also be changed. For example, a change can occur due to the fact that it is recognized in the client that the user navigates in a predetermined direction (i.e. in a direction of the image sequence or in opposition to this direction). If such a direction of navigation is found, this can lead to the fact that, starting from the image currently displayed, now only images in the direction of navigation are obtained from the server.

FIG. 4 shows a variant of a transmission system in which the method according to embodiments of the invention described above can be performed. The transmission system comprises the server SE on which the corresponding image data are present in the form of the segments SG1, SG2, SG3 etc. described above. These segments are deposited in a media memory MS. The server SE also comprises a transmitting means SM which transmits requested segments to a client CL.

The client requests the segments via requests RE at the server. The order in which the segments are requested is then given by the priority rule described above.

For requesting the segments, the client CL comprises a requesting means RM which generates the corresponding requests RE. Furthermore, the client CL comprises a media buffer MB in which the transmitted segments are temporarily stored. The segments stored in the buffer are displayed via a reproduction means DM, e.g. on a screen. In the reproduction means, a decoding unit is provided which decodes the images stored in the buffer in coded form. If necessary, the possibility also exists that the requested images are immediately decoded and thus deposited in the media buffer MB in non-coded form. In this case, multiple decoding of images is avoided if the same image is displayed frequently via the reproduction means. In a further variant, the images are initially deposited in the media buffer in coded form. The images are then decoded during (i.e. briefly before) the initial display and are then kept available/stored in decoded form for a later (repeated) display in the media buffer.

Coding of the segments having the different qualities Q0, Q1 and Q2, shown in FIG. 3, can take place in various ways. In particular, different coding methods, e.g. having correspondingly different image qualities can be used for the individual qualities. Similarly, the different qualities can also represent layers of a scalable coding method. In addition, the coding in the highest quality used can also be a loss-free coding so that no image information is lost which is often desired particularly in the reproduction of medical images.

FIGS. 5 and 6 show two variants how the images or segments can be coded in different quality levels. In FIG. 5, the segments of quality levels Q0 and Q1 correspond to the segments from FIG. 3. According to FIG. 5, the segments SG0 having the lowest quality Q0 are coded on the basis of the video coding standard H.264 using an inter-image prediction. By comparison, segments SG1 having medium quality are coded on the basis of the video coding standard H.265 by means of an inter-image prediction. In distinction to this, a loss-less coding based on the compression standard JPEG-LS is used for the highest quality level Q2. Segments in quality level Q2 always consist of intra-coded images, the length of the segments being different. For example, segments having two images and segments having a single image are shown in FIG. 5 for quality Q2.

FIG. 6 shows a variant in which the segments in the server are coded with a scalable video coding method. The individual qualities Q0, Q1 and Q2 in this case represent corresponding layers of the scalable video coding method. In the case of the scalable video coding, a dependence exists between the images of adjacent layers of different quality levels as is indicated by the vertical arrows in FIG. 6. Scalable video coding methods to be used can be, e.g. H.264-SVC or H.265-SHVC.

As already described above, the priorities can be adapted by the user during procurement of the images from the server, if necessary. For example, images can first be downloaded with the lowest quality Q0 before these images are then requested with higher quality, e.g. in a loss-less format. Similarly, the priorities can be adapted in dependence on the conditions on the transmission link between server and client, if necessary. For example, corresponding images having a higher quality can be obtained at a higher data rate whereas the images are first downloaded in poorer quality in the case of a deterioration of the data rate.

FIG. 7 shows by way of example a snapshot of the images stored in the buffer of a client. The predefined image sequence BR again extends from left to right. The current point of reproduction is indicated by the reference symbol VP and a preceding point of reproduction is designated by the reference symbol VP′. In addition, images not yet transmitted to the client are reproduced dashed and indicated with the reference symbol B″.

The images transmitted to the client are available in four quality levels according to FIG. 7. For quality level Q0, the so-called “Base Layer” having the lowest resolution from the H.264/AVC standard was used (resolution: 256×256 pixels) (AVC=Advanced Video Coding). By comparison, the so-called “Spatial Enhancement Layer” having a higher local resolution from H.264-SVC was used for the quality Q1 (local resolution: 512×512 pixels). For the quality Q2, the so-called “Quality Enhancement Layer” from H.264-SVC was used in which the local resolution remains the same compared with the quality Q1, but other properties of the image with higher quality are available. For the highest quality level Q3, finally, a loss-less coding based on the JPEG-LS standard having a local resolution of 512×512 pixels was used.

According to the current reproduction shown in FIG. 7, an image of the highest quality level is currently displayed at the client. During this display, the further images B″ are now downloaded according to the specified priority sequence. FIG. 7 also shows that, if necessary, the local resolution of the series of images can also be varied with reference to the spatial direction of the image sequence BR. This can be seen for the qualities Q0 and Q1 in which only every second image was temporarily downloaded with reference to the image sequence BR.

The embodiments of the method according to embodiments of the invention, described in the preceding text, have a series of advantages. In distinction from a downloading of the entire set of image data, an image reproduction without long initial delay is enabled by streaming images. The user (e.g. a doctor) can thus have images displayed immediately from the record desired by him. In addition, it is no longer required that the entire record has to be transmitted from server to client but now only the areas requested by the client. Since, as a rule, only relevant segments are obtained from the server and buffered in the client, a user perceives no delay during the navigation in the images which is not the case with streaming at the server.

Due to the buffering of transmitted images, the same image does not have to be transmitted twice when it is displayed again to the client. In distinction from this, segments are immediately discarded after decoding in the case of streaming at the server. Due to the buffering, it is also possible to navigate in the image data if the link to the server is lost, which is not possible in the case of streaming at the server.

In distinction from conventional adaptive streaming, adjacent images are obtained both in and in opposition to a predetermined image sequence during the reproduction of a current image or, respectively, a version having a higher image quality is downloaded for the current image. In this way, an improved and very flexible navigation in the image data is achieved. In addition, there may also be the possibility that due to the adaptation of the priority rule described above, the sequence of images obtained is adapted to different events or circumstances, e.g. in dependence on a user request or in dependence on the transmission rate between server and client.

The client, the server and/or the respective associated means of the client and/or of the server can be implemented in software, hardware or in a combination of software and hardware. The respective means, the server or the client can be designed, with the aid of a respective processor, with a storage unit for depositing machine-readable commands of the software and with an input/output unit for exchanging information.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A method for transmitting digital images from a series of images for which an image sequence of the series of images is specified, the series of images being stored in a form of segments on a server and a respective segment comprising one or more images which are adjacent to one another according to the image sequence, a client requesting images on a basis of the segments at the server which thereupon transmits the images from the requested segments at least partially to the client, in which the images are stored in a buffer and reproduced at least in part, the method comprising:
checking, by the client, at a time of reproduction of a current image the requesting of further images from the server on the basis of a specified priority rule, in the course of checking the requesting of a respective further image the client requesting a segment which comprises the respective further image if the respective further image is not present in the buffer;
wherein the specified priority rule is designed in such a manner that the client first checks the requesting of further images which follow the current image both in the direction of the image sequence and in opposition to the direction of the image sequence, and/or first the requesting of at least one further image is checked which corresponds to the current image in a higher image quality than that of the current image.

2. The method as claimed in claim 1, in which specified identical image contents are in each case described by a number of segments having different image qualities, the number of segments differing in the image quality of the images contained therein.

3. The method as claimed in claim 1, in which the segments comprise coded images which are decoded for display at the client.

4. The method as claimed in claim 2, in which the segments having the different image qualities are coded with different coding methods and/or different quality levels of the same coding method.

5. The method as claimed in claim 4, in which the different coding methods comprise H.264 and/or H.265 and/or JPEG-LS and/or JPEG-lossless and/or the different quality levels of the same coding method relate to layers of a scalable video coding, particularly to layers of H.264-SVC and/or layers of H.264-SHVC.

6. The method as claimed in claim 3, in which the images are stored at least in part in decoded form in the buffer in the client.

7. The method as claimed in claim 1, in which the transmission of the digital images takes place on the basis of the MPEG-DASH-standard.

8. The method as claimed in claim 1, in which the specified priority rule is altered in dependence on predetermined events.

9. The method as claimed in claim 8, in which the specified priority rule is altered in dependence on the data rate of the transmission from the server to the client, the alteration of the priority rule being designed in such a manner that the client requests images having a higher image quality at higher data rates than at lower data rates.

10. The method as claimed in claim 8, in which the specified priority rule can be altered by a user command input at the client for altering the specified priority rule.

11. The method as claimed in claim 1, in which a direction of navigation is determined by the client on the basis of the movement of the current images in the direction or in opposition to the direction of the image sequence, wherein, according to the specified priority rule and/or according to the altered priority rule, the client requests, starting from the image currently reproduced those other images which follow the current image in the direction of navigation, preferably in comparison with those other images which follow the current image in opposition to the direction of navigation.

12. The method as claimed in claim 1, in which the specified priority rule and/or the altered priority rule specifies that for particular segments requested by the client, only a part of the images contained therein are transmitted from the server to the client.

13. The method as claimed in claim 1, in which the series of images comprises digital medical images which represent sections of a human or animal body which follow one another in a spatial direction, the spatial direction corresponding to the image sequence.

14. A system of server and client for transmitting digital images from a series of images for which an image sequence of the images is specified, the series of images being stored in the form of segments on the server and a respective segment comprising one or more images which, according to the image sequence, are adjacent, wherein
the client comprises:
a requesting means for requesting images on the basis of the segments at the server;
a buffer for storing images from the series of images;
a reproducing means for reproducing at least a part of the images from the buffer;
the server comprises:
a memory in which the stored images are stored;
a transmitting means for transmitting the images from the segments requested by the client at least partially to the client;
the requesting means of the client being designed in such a manner that:
the requesting means checks at the time of reproduction of a current image by the reproducing means the requesting of further images by the server on the basis of a specified priority rule, in the course of checking a respective further image the requesting means requesting a segment which comprises the respective further image if the respective further image is not present in the buffer;
wherein the priority rule is designed in such a manner that initially the requesting of further images is checked which follow the current image both in the direction of the image sequence and in opposition to the direction of the image sequence and/or initially the requesting of at least one further image is checked which corresponds to the current image in a higher image quality than that of the current image.

15. (canceled)

16. A client for use in a system for transmitting digital images from a series of images for which an image sequence of the images is specified, the series of images being stored on a server in the form of segments and a respective segment comprising one or more images which are adjacent in accordance with the image sequence,
wherein
the client comprises:
a requesting means for requesting images on the basis of the segments at the server and by this means to cause the server to transmit the images from the requested segments at least partially to the client;
a buffer for storing images from the series of images;
a reproducing means for reproducing at least a part of the images from the buffer;
the requesting means of the client being designed in such a manner that:
the requesting means checks at the time of reproduction of a current image by the reproducing means the requesting of further images by the server on the basis of a specified priority rule, in the course of checking a respective further image the requesting means requesting a segment which comprises the respective further image if the respective further image is not present in the buffer;
the priority rule being designed in such a manner that initially the requesting of further images is checked which follow the current image both in the direction of the image sequence and in opposition to the direction of the image sequence and/or initially the requesting of at least one further image is checked which corresponds to the current image in a higher image quality than that of the current image.

17. (canceled)
